(19) United States
(12) Patent Application Publication
(10) Pub. No.: US 2016/0335673 A1
(43) Pub. Date: Nov. 17, 2016

(54) SMART LISTS

(71) Applicant: Xero Limited, San Francisco, CA (US)

(72) Inventor: Craig Walker, New York, NY (US)

(21) Appl. No.: 14/709,884

(22) Filed: May 12, 2015

(51) Int. Cl. G06Q 30/02; G06F 17/30

(52) U.S. Cl. CPC G06Q 30/0269; G06F 17/30864; G06F 17/30554

(57) ABSTRACT

A system is disclosed as having a display device, one or more processors, and a non-transitory machine readable medium coupled to the processors. The non-transitory machine readable medium stores instructions which cause the one or more processors to receive data indicative of entity information for a set of entities. The processor presents an entity search tool comprising a plurality of search criteria sets. Each search criteria set comprising a first selector, a second selector, and a third selector. The processor receives a selection in the first selector, the second selector, and the third selector. The selections are indicative of selected search criteria. The processor identifies a result indicative of at least a portion of the entity information from the one or more entity corresponding to the selected search criteria. The processor presents the result on the display device.

### TECHNICAL FIELD

The present disclosure generally relates to intelligent and flexible entity transaction systems and/or methods.

### BACKGROUND

For a small business, it may cost six times more to acquire new customers than to retain existing customers. In both cases, generating, transforming, and summarizing information on entities is a tough task.

Targeted marketing attempts to use information about an entity, or a potential customer, in order to supply that entity with advertisements and product offers in which it may be interested. For example, in order to determine the products in which a potential customer may have some interest, individuals and companies engaged in targeted marketing may make assumptions about the potential customer given the information about that potential customer. For example, if a potential customer has been identified as purchasing a first item, a targeted marketing strategy might be to offer the potential customer a related second product that may be used in conjunction with the first product.

Although small businesses retain information about existing customers and entities in general, these businesses often lack the resources, technical know-how, intelligent system, and tools needed to reconcile the retained information into useful targeted promotional materials or targeted promotional databases linking existing entities with products in which they may be interested.

### BRIEF DESCRIPTION OF THE DRAWINGS

Some embodiments are illustrated by way of example and not of limitation in the figures of the accompanying drawings.

FIG. 1 is a block diagram depicting an example single ledger accounting platform, according to some embodiments.

FIG. 2 is a block diagram depicting an example accounting application framework for the accounting platform, according to some embodiments.

FIG. 3 is a block diagram depicting an example hosting infrastructure for the accounting platform, according to some embodiments.

FIG. 4 is a block diagram depicting an example data center system of the accounting platform, according to some embodiments.

FIG. 5 is a block diagram depicting an example client device for accessing the accounting platform, according to some embodiments.

FIG. 6 is an interface diagram depicting an example user interface displaying features of a smart list generation application, according to some embodiments.

FIG. 7 is an interface diagram depicting an example user interface displaying features of a smart list generation application, according to some embodiments.

FIG. 8 is an interface diagram depicting an example user interface displaying features of a smart list generation application, according to some embodiments.

FIG. 9 is an interface diagram depicting an example user interface displaying features of a smart list generation application, according to some embodiments.

FIG. 10 is a flowchart of an example method for generating a result list from customer data, according to some embodiments.

FIG. 11 is an interface diagram depicting an example user interface displaying features of a smart list generation application, according to some embodiments.

FIG. 12 is a flowchart of an example method for generating a result list from customer data, according to some embodiments.

FIG. 13 is a flowchart of an example method for generating a contact list from a generated result list, according to some embodiments.

FIG. 14 is a block diagram of a machine in the example form of a computer system within which a set of instructions, for causing the machine to perform any one or more of the methodologies discussed herein, may be executed, according to some embodiments.

### DETAILED DESCRIPTION

Example systems and methods for generating intelligent smart lists containing targeted entity information, as well as related administrative systems and methods, are described herein. In some embodiments, the example systems and method generate entity transaction data by generating smart lists. In some embodiments, the entity transaction data is a set of entity transaction data comprising one or more customer transactions. In the following description, for purposes of explanation, numerous specific details are set forth in order to provide a thorough understanding of example embodiments. It will be evident, however, to one skilled in the art that the present technology may be practiced without these specific details.

The technology described herein provides a smart list generation application that enables the real-time generation of entity transaction data. In some embodiments, the smart list generation application may be used to generate entity transaction data to create entity lists tailored to transmit data to a set of entities, such as for targeted marketing or product promotion campaigns. The smart list generation application may be associated with an accounting system that manages accounting aspects for a business. The smart list generation application can access the accounting system (e.g., over a network) to obtain business records and banking records associated with the business or business and transaction records for entities to which the smart list generation application has been provided access.

A business record includes any records associated with a particular transaction performed by a business, such as an invoice or receivable record associated with an amount owed to the business by a payee, a bill or payable record associated with money spent by the business, and the like. A banking record may include any records associated with a financial institution, including a record indicating receipt of payment of a particular amount at an account of the financial institution, a record indicating a withdrawal from the account for a particular amount, and the like.

The banking records and business records may be displayed in any suitable manner. In some embodiments, the records are displayed as a set of cards that a user can scroll and/or flip through (e.g., using the touch screen of the mobile device).

The smart list application may enable a user to correlate and customize entity information including, contact information, purchase information, and sales information, generated through the user's business. For example, the smart list application may enable a user to identify entities to target those customers for a specific promotion, discount, advertisement, or the like. The smart list application may enable users to determine which entities have paid invoices, which entities are overdue, and to which entities to send additional or follow-up invoices. Additionally the smart list application may enable a user to determine the number of entities within a particular city, region, state, or other geographical location to better understand entities base, entities needs, entities buying habits, and the like.

By way of further example, the smart list application may enable the user to generate and save customized data configurations representative of searches of the entity information, contact information, purchase information, and sales information as well as generate and save generated lists (e.g., customer lists) based on the searches performed on said data. In this manner, the user may be able to generate contact lists for transmitting data, to a subset of entities, including promotional materials, invoicing, targeted marketing, rewards, and the like. Contact lists and the transmission of promotional or targeted marketing materials or correspondence may be performed through the smart list application, in conjunction with the smart list application using a second application, or through a third party to whom the contact list may be transmitted.

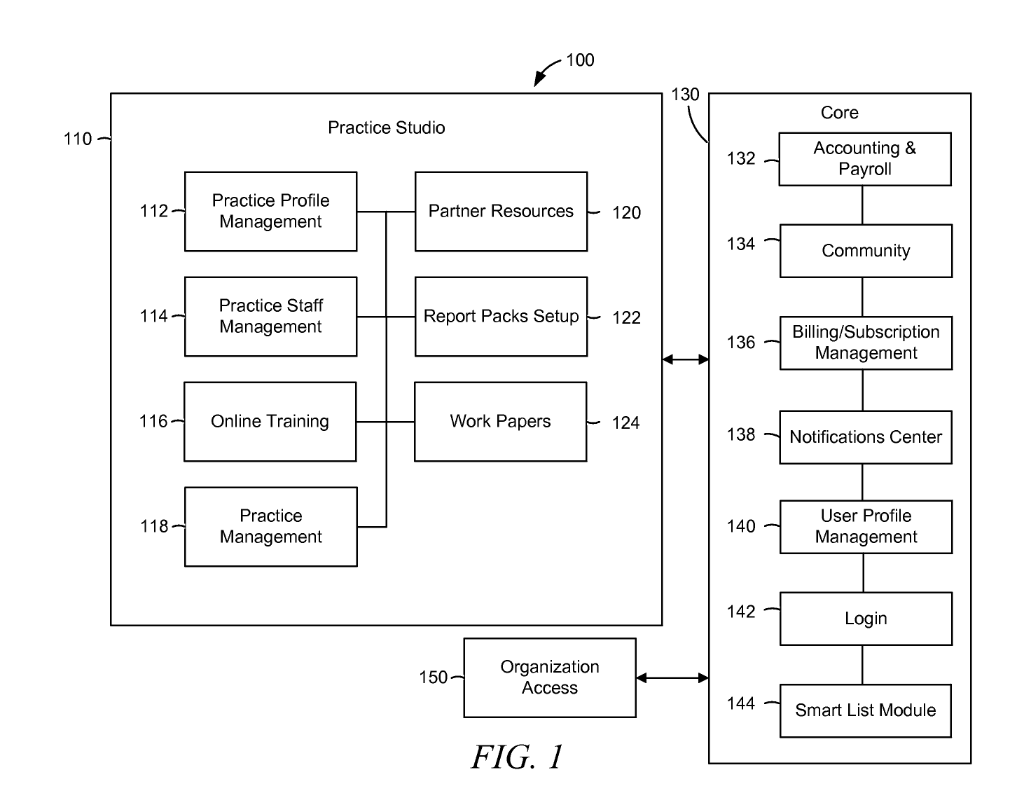

FIG. 1 is a block diagram depicting an example single ledger accounting system 100, according to some embodiments. A single ledger accounting system 100 may provide accounting tools to a particular entity managing accounting for one or more businesses. The example single ledger accounting system 100 may include a practice studio 110 that allows an entity to manage one or more businesses and an organization access module 150 that provides a business with tools for managing accounting data for that particular business. The practice studio 110 may include a practice profile management module 112, a practice staff management module 114, an online training module 116, a practice management module 118, a partner resources module 120, a report packs setup module 122, and a work papers module 124. The practice studio 110 may be in communication with the core features 130. The core features 130 may include an accounting and payroll module 132, a community module 134, a billing/subscription management module 136, a notifications center module 138, a user profile management module 140, and a login module 142. The organization access module 150 may be in communication with the core features 130. The practice studio 110 and core features may be accessed by an entity using login module 142.

As shown in FIG. 1, features of the system are divided into three areas based on the target user. The features of the practice studio 110 provide a suite of tools for accountants to interact with their clients and manage their practices. The core features 130 provide the core functionality and user tools common to both accountants and businesses. The organization access module 150 provides a user interface for individual businesses to access their data.

Practice studio 110 is the central login for accountants. For example, an accountant with multiple clients, each of which is a small business, can login using practice studio 110 and gain access to the accounting data for the clients, messages from the clients, and so on.

The practice profile management module 112 allows an accounting practice to manage and view its profile settings. For example, an accounting practice may have a partner level, representing the strength of its relationship with the provider for the accounting platform. The partner level may be based on the number of clients associated with the accounting practice in the accounting platform. For example, a bronze partner level may be assigned to accounting practices with at least 5 clients, a silver partner level assigned to accounting practices with at least 20 clients, and a gold partner level assigned to accounting practices with at least 100 clients. Alternatively or additionally, the accounting practice may have one or more certifications provided by the accounting platform. The certifications may be provided automatically based on the completion of an online test and may expire after the elapse of a predetermined period (e.g., one year). Other profile settings may include the name, address, telephone number, email address, and so forth of the accounting practice.

The practice staff management module 114 provides the ability for the manager of an accounting practice to control settings for the staff of the practice. For example, some staff members may have read-only access to data for certain clients, some staff members may have read-write access for certain clients, some staff members may be able to modify the access permissions for other staff members, and so on.

The online training module 116 provides training for accountants and their staff. In some cases, the provided training includes one or more video presentations and one or more online tests. Notification of passing a test at completion of training may be provided. For example, a staff member may take a training course and, upon successful completion, the accountant supervising the staff member may receive a notification of the successful completion.

The practice management module 118 provides services for accountants. Access to the features provided by the practice management module 118 may be limited to accountants having a predetermined partner level with the accounting platform provider. For example, access to the practice management module 118 may be limited to accountants at silver level or above. The services provided by the practice management module 118 may include workflow tools, customer relationship management (CRM) tools, lead generation tools, job management tools, invoice generation tools, and so forth.

The partner resources module 120 provides information regarding third-party partners. For example, a third party may provide tools that interact with the system to provide useful functionality beyond that of the system alone. The user can access the partner resources module 120 to learn about available third-party tools. For example, links to third-party websites, documentation, videos, and search tools may all be provided.

The report packs setup module 122 provides tools to allow accountants to create and generate standardized sets of reports. For example, a profit and loss statement and quarterly report could both be added to a pack. The accountant would then be able to easily generate both reports for any selected client or generate the reports for every client.

The work papers module 124 provides tools for accountants to interactively create financial reports. For example, an accountant can enter known data for a client into the work paper and then send the work paper to the client with an indication of data needed from the client. After the client enters the missing data into the work paper, the accountant can complete the report.

The core features 130 include modules that are used both by accountants and organizations. The accounting and payroll module 132 provides the general ledger for organizations. The general ledger may be integrated with the organization's payroll, bypassing the separate step of entering payroll data into the general ledger each pay period. The accounting and payroll module 132 accesses banking data for each client business. The banking data may be imported either through a bank feed or a user- or accountant-created document. The accounting and payroll module 132 may also communicate with third-party tools via an application protocol interface (API).

The community module 134 provides a forum through which users can communicate. For example, a user with a question may post a topic in the forum and later receive a helpful response from another user. Information taken from the user profile (e.g., the user profile managed via the user profile management module 140) may appear along with forum posts by the user. For example, a user name, an image of the user, and the user's status as an accountant or member of an organization may each be shown.

The billing/subscription management module 136 allows a user to configure one or more billing accounts for each organization using the system. The system may periodically charge a subscription fee for access (e.g., a monthly or annual subscription fee). The subscription fee may be automatically deducted from the one or more billing accounts.

The notifications center 138 provides notifications to users. For example, users may send messages to each other, which appear as notifications. Notifications may also be created by the system (e.g., by accounting and payroll module 132) based on events. For example, a minimum account balance for a particular bank account may be set by a user via the accounting and payroll module 132. When the balance for that bank account drops below the minimum account balance, a notification can be generated by the system to inform the user.

The user profile management module 140 allows a user to manage the profile of the user's organization and the profiles of others based on permission settings. For example, an accountant may have permission to manage the profiles of the accountant's clients. The profile may include public-facing information such as a business name and address.

The login module 142 verifies the identity of a user logging into the system (e.g., via user name and password). Based on the user's identity, a user interface is presented that includes a list of organizations that a user has access to. For most small business clients, the list will consist of a single organization.

The smart list module 144 enables a user to interact with data entered into the accounting and payroll module 132, the billing/subscription module 136, and the notifications center 138, for example, to perform data processing operations on data corresponding to entity information, as will be explained below in more detail.

The organization access module 150 accesses the core features 130 for a single organization. The organization access module 150 presents, after user verification by the login module 142, a user interface with options for a single organization without the additional features used only by the practice studio 110.

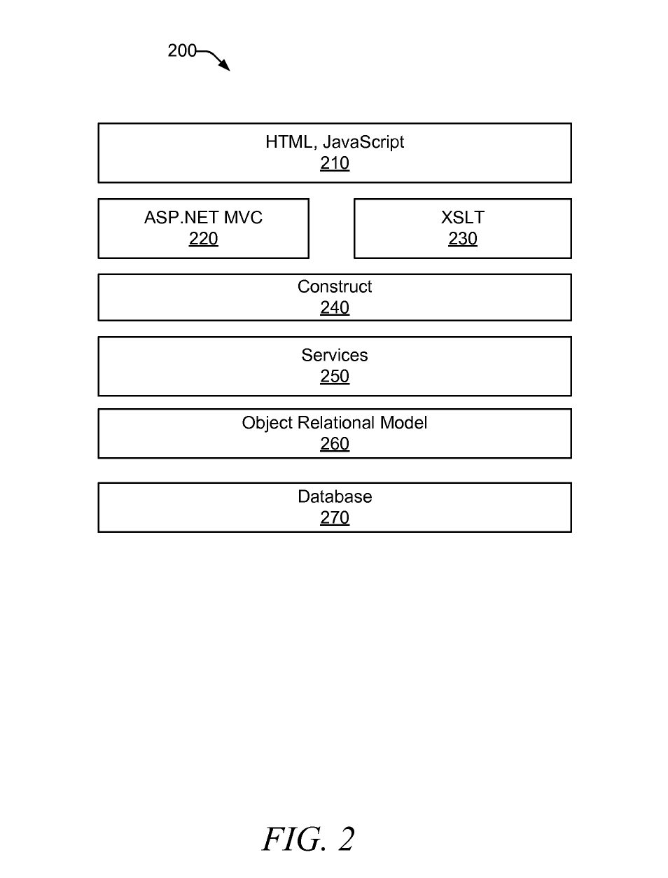

FIG. 2 is a block diagram depicting an example accounting application framework 200 for the accounting platform, according to some embodiments. The accounting application framework 200 may be an end-to-end web development framework enabling a “software as a service” (SaaS) product. The accounting application framework 200 may include a hypertext markup language (HTML) and/or JavaScript layer 210, ASP.Net Model-View-Controller (MVC) 220, extensible stylesheet language transformations (XSLT) 230, construct 240, services 250, object relational module 260, and database 270.

The HTML and/or JavaScript layer 210 provides client-side functionality, such as UI generation, receipt of user input, and communication with a server. The client-side code may be created dynamically by the ASP.NET MVC 220 or the XSLT 230. Alternatively, the client-side code may be statically created or dynamically created using another server-side tool.

The ASP.Net MVC 220 and XSLT 230 provide server-side functionality, such as data processing, web page generation, and communication with a client. Other server-side technologies may also be used to interact with the database 270 and create an experience for the user.

The construct 240 provides a conduit through which data is processed and presented to a user. For example, the ASP.Net MVC 220 and XSLT 230 can access the construct 240 to determine the desired format of the data. Based on the construct 240, client-side code for presentation of the data is generated. The generated client-side code and data for presentation is sent to the client, which then presents the data.

The services 250 provide reusable tools that can be used by the ASP.Net 220, the XSLT 230, and the construct 240 to access data stored in the database 270. For example, aggregate data generated by calculations operating on raw data stored in the database 270 may be made accessible by the services 250.

The object relational model 260 provides data structures usable by software to transform data stored in the database 270. For example, the database 270 may represent a many-to-one relationship by storing multiple rows in a table, with each row having a value in common. By contrast, the software may prefer to access that data as an array, where the array is a member of an object corresponding to the common value. Accordingly, the object relational model 260 may convert the multiple rows to an array when the software accesses them and perform the reverse conversion when the data is stored.

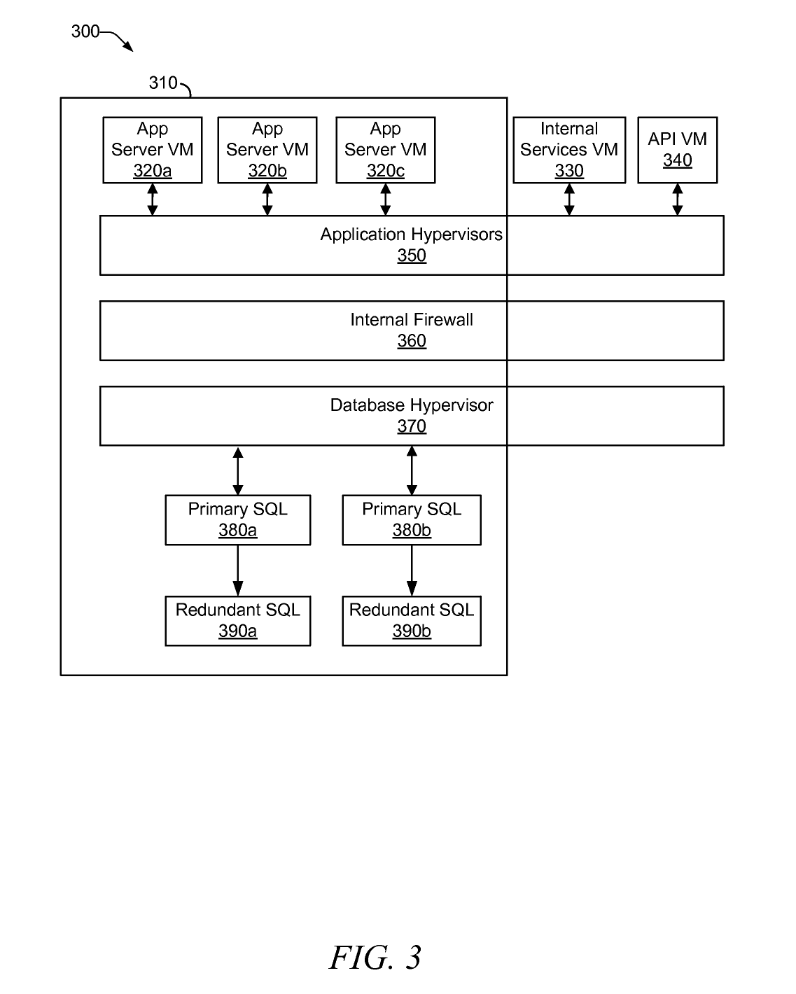

FIG. 3 is a block diagram depicting an example hosting infrastructure 300 for the accounting platform, according to some embodiments. The platform may be implemented using one or more pods 310. Each pod 310 includes application server virtual machines (VMs) 320 (shown as application server virtual machines 320a-320c in FIG. 3) that are specific to the pod 310 as well as application server virtual machines that are shared between pods 310 (e.g., the internal services VM 330 and the application protocol interface VM 340). The application server virtual machines 320-340 communicate with clients and third-party applications via a web interface or an API. The application server virtual machines 320-340 are monitored by application hypervisors 350. In some example embodiments, the application server virtual machines 320a-320c and the API VM 340 are publicly-accessible while the internal services VM 330 is not accessible by machines outside of the hosting infrastructure 300. The app server VMs 320a-320c may provide end-user services via an application or web interface. The internal services VM 330 may provide back-end tools to the app server VMs 320a-320c, monitoring tools to the application hypervisors 350, or other internal services. The API VM 340 may provide a programmatic interface to third parties. Using the programmatic interface, the third parties can build additional tools that rely on the features provided by the pod 310.

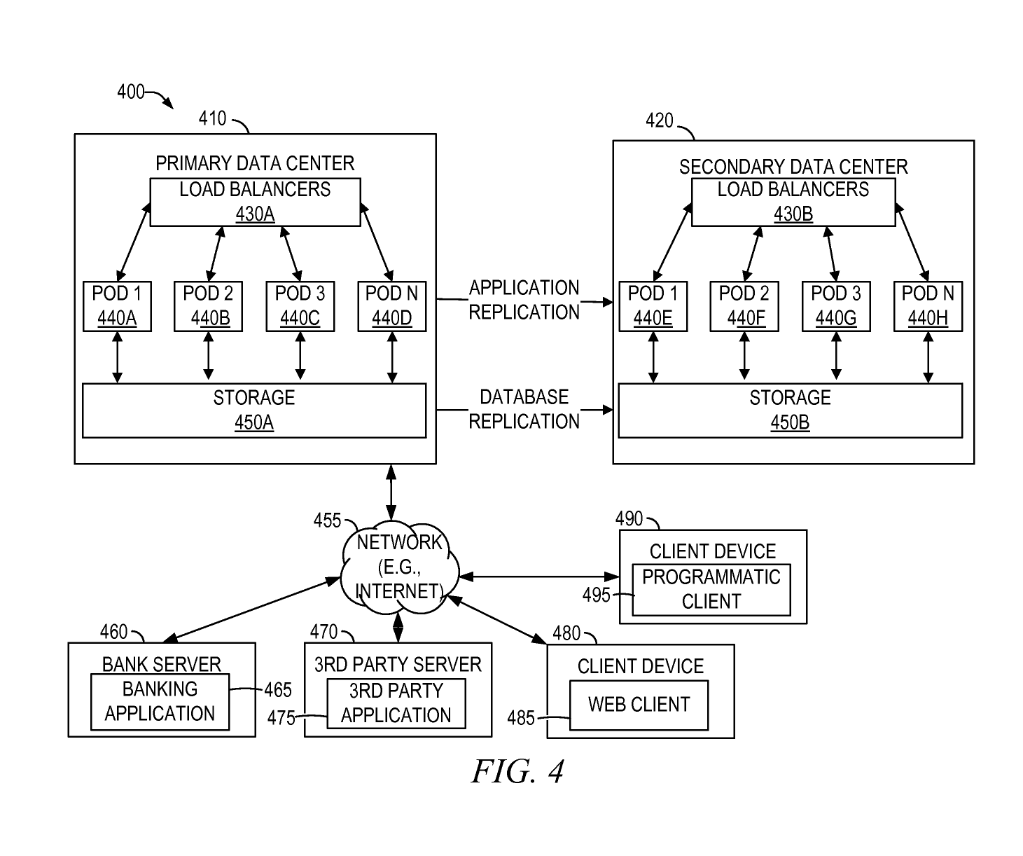

The internal firewall 360 ensures that only approved communications are allowed between the database hypervisor 370 and the publicly-accessible virtual machines 320-340. The database hypervisor 370 monitors the primary SQL servers 380a and 380b. The primary SQL servers 380a and 380b access the shared storage layer 450a or 450b (shown in FIG. 4) to read and write data generated by or used by the application server virtual machines 320-340. The redundant SQL servers 390a and 390b provide backup functionality for the primary SQL servers 380a and 380b, respectively.

The virtual machines 320-340 can be implemented using Windows 2008 R2, Windows 2012, or another operating system. The application and support servers supporting the virtual machines 320-340 can be built using spares for redundancy. The support servers can be shared across multiple pods 310. The application hypervisors 350, internal firewall 360, and database hypervisor 370 may span multiple pods 310 within a data center. In some example embodiments, each primary SQL server 380 and redundant SQL server 390 is configured to support 30,000-45,000 organizations. Accordingly, in embodiments using two such server pairs per pod 310, the pod capacity is 60,000-90,000 organizations. The redundant SQL servers 390 may take advantage of the “always on” resilience feature of SQL 2012.

FIG. 4 is a block diagram depicting an example data center system 400 of the accounting platform interacting with other systems over a network, according to some embodiments. The primary data center 410 services entity requests and is replicated to the secondary data center 420. The secondary data center 420 may be brought online to serve entity requests in case of a fault in the primary data center 410. The primary data center 410 communicates over a network 455 with bank server 460, third party server 470, client device 480, and client device 490. The bank server 460 provides banking data (e.g., via the banking application 465). The third party server 470 is running third party application 475. Client devices 480 and 490 interact with the primary data center 410 using web client 485 and programmatic client 495, respectively.

Within each data center 410 and 420, a plurality of pods, such as the pod 310 of FIG. 3, are shown. The primary data center 410 is shown containing pods 440a-440d. The secondary data center 420 is shown containing pods 440e-440h. The applications running on the pods of the primary data center 410 are replicated to the pods of the secondary data center 420. For example, EMC replication (provided by EMC Corporation) in combination with VMWare site recovery manager (SRM) may be used for the application layer replication. The database layer handles replication between the storage layer 450a of the primary data center and the storage 450b of the secondary data center. Database replication provides database consistency and the ability to ensure that all databases are at the same point in time.

The data centers 410 and 420 use load balancers 430a and 430b, respectively, to balance the load on the pods within each data center. The data centers 410 and 420 can be created using identical hardware to ensure that the performance of the secondary data center 420 is the same as the performance of the primary data center 410. The storage 450 may be implemented using one or more EMC VNX storage area networks.

The bank server 460 interacts with the primary data center 410 to provide bank records for bank accounts of the client. For example, the client may provide account credentials to the primary data center 410, which the primary data center 410 uses to gain access to the account information of the client. The bank server 460 can provide the banking records to the primary data center 410 for later reconciliation by the client using the client device 480 or 490.

The third party server 470 may interact with the primary data center 410 and the client device 480 or 490 to provide additional features to a user of the client device 480 or 490. For example, a user may authorize the third party server 470 to access the user's data stored in the primary data center 410. The third party application 475 of the third party server 470 may use the user's data to generate reports, provide macros, or otherwise improve the user's ability to access or transform the user's data. The third party application 475 may communicate with the primary data center 410 via the network 455 using an API. The third party application 475 may communicate with the client device 480 or 490 using a web or programmatic interface.

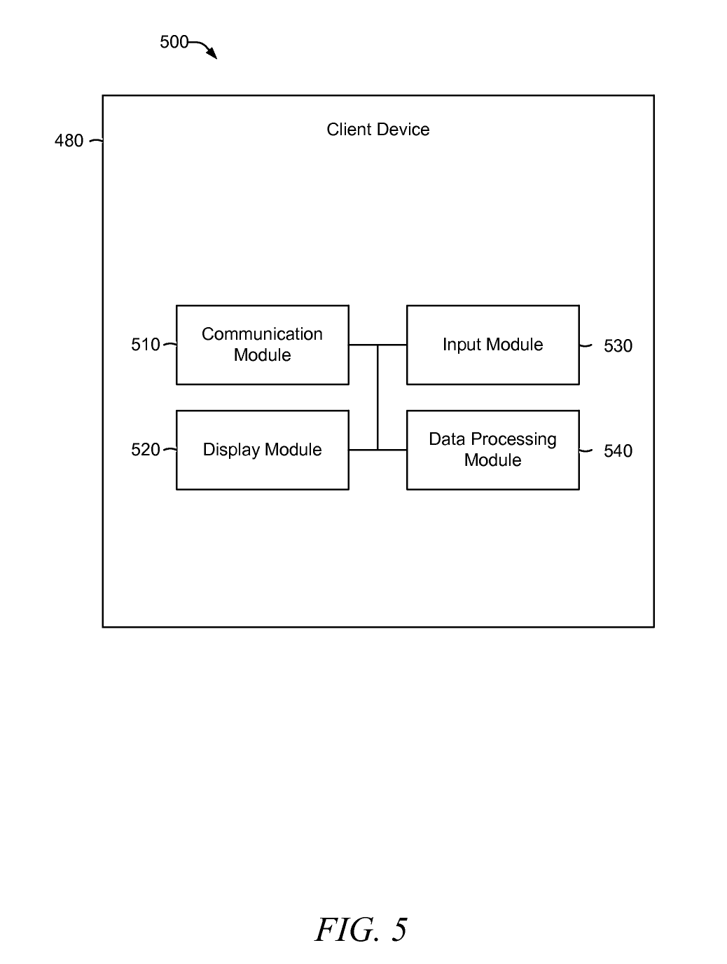

FIG. 5 is a block diagram 500 illustrating components of a client device suitable for the smart list generation application, according to some example embodiments. The client device 480 or 490 is shown as including a communication module 510, a display module 520, an input module 530, and a data processing module 540, configured to communicate with each other (e.g., via a bus, shared memory, or a switch).

The communication module 510 may communicate with the primary data center 410, the third party server 470, the network 455, or any suitable combination thereof. Information received via the communication module 510 may be presented (e.g., displayed on a display device) via the display module 520. Information may be selected or search queries may be entered by a user of the client device 480 or 490.

A user interface is presented by the display module 520. The input from the user is detected by the input module 530. Commands received from the user by the input module 530 may be communicated to the primary data center 410 by the communication module 510. The communication module 510 may receive a response from the primary data center 410 that includes a set of banking records, a set of business records, associations between individual banking records and individual business records that indicate reconciliation between those records, and other data, in any combination.

The data processing module 540 can generate requests to the primary data center 410 to indicate that a banking record is reconciled by one or more business records. The request can be communicated to the primary data center 410 via the communication module 510 over the network 455.

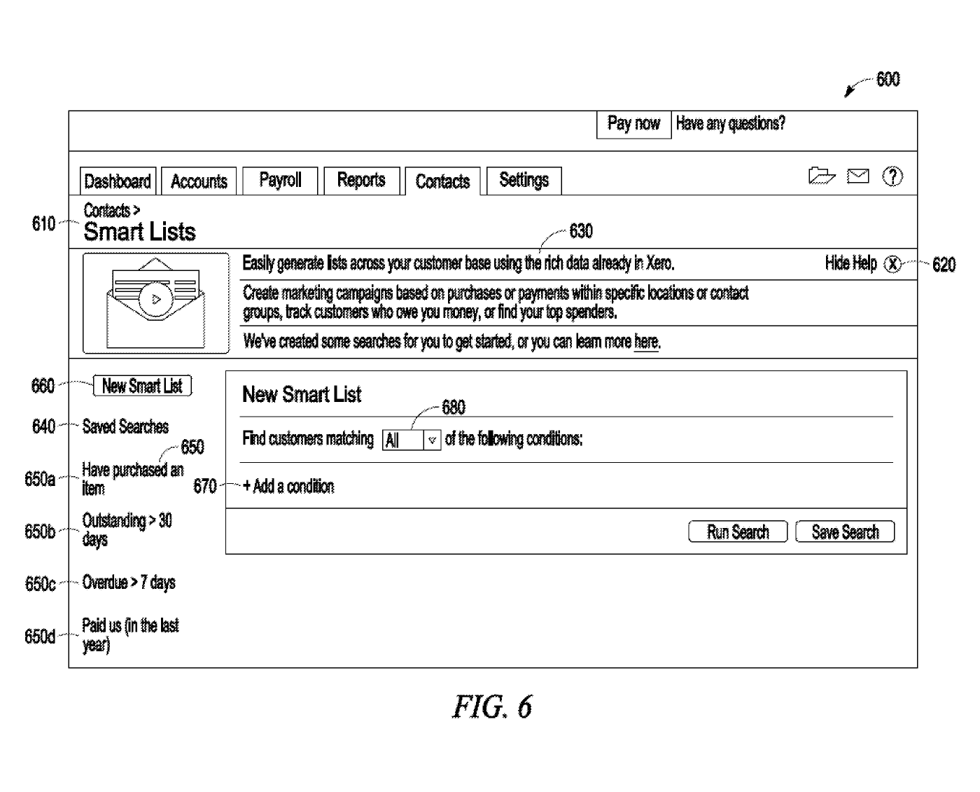

FIG. 6 is an interface diagram depicting an example user interface of an entity search tool 600 displaying features of a smart list generation application, according to some embodiments. The entity search tool 600 includes a title 610, a help element 620, a help tip 630, a saved search list 640, a set of saved searches 650 (shown in FIG. 6 as a set of saved searches 650a-d), a new list element 660, a data field addition element 670, and a set of data entry fields 680 accessed through the data field addition element 670. Although the entity search tool 600 is depicted as implemented on an internet browser, it will be understood by one skilled in the art that the entity search tool 600 may be implemented on any internet browser. Further, although the entity search tool 600 is shown using an internet browser, it will be understood by one skilled in the art that the entity search tool 600 may be implemented as a mobile application, a desktop application, a desktop computer program, or any other suitable program with a graphical user interface.

The title 610 shows the name of the current user interface. In the example shown, the name is “Smart Lists.” The title 610 may be used to distinguish between user interfaces for distinct applications within a single program. For example, a single program, the single ledger accounting platform, may contain the entity search tool 600 when an interface option is selected. The single program may additionally contain other user interfaces for additional applications, selected using the same or a different interface option.

The help element 620 may be selectable to show or hide the help tip 630. In some embodiments, selection of the help element 620 may generate or retrieve a random help tip 630. In some embodiments, the help element 620 may be implemented as a data entry field, enabling the user to search or otherwise identify a topic for which the user is requesting a defined help tip 630. The help tip 630 may be a random help tip 630 or a defined help tip 630 and may provide instruction, suggestion, usage information, or other appropriate information to the user regarding use of the entity search tool 600.

The saved search list 640 may be implemented as a selectable element capable of displaying, or removing from display, the set of saved searches 650. For example, in some embodiments, the saved search list 640 may be a collapsible menu capable of expanding or collapsing the set of saved searches 650 to enable the user to view a representative title of each of the set of saved searches 650 or hide the set of saved searches 650, leaving only the saved search list 640 element as viewable on the entity search tool 600. In some embodiments, the saved search list 640 may be implemented as a title above the set of saved searches 650 and may not enable hiding of the titles of the set of saved searches 650.

The set of saved searches 650 may be displayed using a title 652 indicative of each of the set of saved searches 650. For example, in FIG. 6, the set of saved searches 650 is shown as a set of four saved searches 650a-d with a set of four titles 652a-d, each indicating a separate saved search.

The new list element 660 may be a selectable element enabling the user to create a new saved search and add that saved search to the set of saved searches 650. For example, the user may select the new list element 660, enter a title, and select one or more of a set of data entry fields with predetermined search criteria. The user may then save that search corresponding to the title and a configuration of the one or more selections of the set of data entry fields. The newly saved search may then be transferred to the set of saved searches 650.

In some embodiments, the set of saved searches 650, or a subset of the set of saved searches 650, may be generated by the smart list module 144. For example, the smart list module 144 may generate or create a saved search based on a commonly used set of search criteria. In some embodiments, the smart list module 144 may be preconfigured to include a default set of saved searches. For example, the smart list module 144 may include the default set of saved searches having an accounting related content (e.g., a default search for overdue invoices).

Further, in some embodiments, the set of saved searches 650, where implemented as a default set of saved searches, may be modified by a user. For example, the user may load the “have purchased an item” saved search, from the default set of searches. The user may then transform the set of data entry fields to limit the “have purchased an item” to include a specific time limit, a specific item, or the like. The user may then save the search with a selectable element in the entity search tool 600, thereby modifying the default saved search.

The data field addition element 670 may be a selectable element enabling the user to perform searches of data entered into the single ledger accounting system 100 through the entity search tool 600. The data field addition element 670 may be used to add data entry fields into a search. For example, the user may select the data field addition element 670 and select from a set of data entry fields having predetermined search criteria. The user may select one or more of the set of data entry fields to generate a search specifying a subset of the data entered into the single ledger accounting system 100.

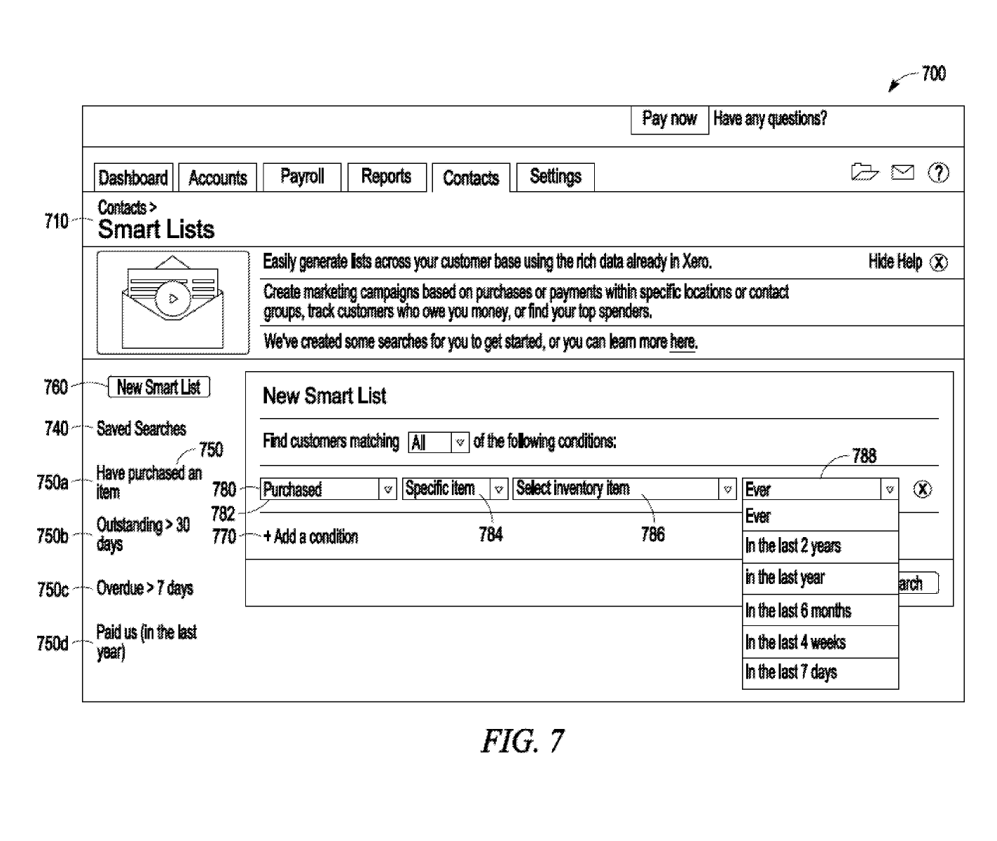

FIG. 7 is an interface diagram depicting an example embodiment of an entity search tool 700 displaying features of the smart list generation application, according to some embodiments. The entity search tool 700 includes a title 710, a help element 720, a help tip 730, a saved search list 740, a set of saved searches 750 (e.g., saved searches 750a-750d), a new list element 760, a data field addition element 770, and a set of data entry fields 780 forming a search criteria set. Each data entry field of the set of data entry fields 780 may be understood to be a selector configured to enable selection of at least one search criterion or category from a set of search criteria or categories presented within the selector. The search criteria set of the set of data entry fields 780 forms a search query. The search criteria set comprises a plurality of search criterion including a category parameter field 782, a first search criterion field 784, and a second search criterion field 786. As shown in FIG. 7, the search criteria set can include one or more additional search criterion fields, such as a third search criterion field 788. The title 710, the help element 720, the help tip 730, the saved search list 740, the set of saved searches 750, the new list element 760, and the data field addition element 770 are similar to the title 610, the help element 620, the help tip 630, the saved search list 640, the set of saved searches 650, the new list element 660, and the data field addition element 670, respectively, as described above with respect to FIG. 6.

The set of data entry fields 780 may form a first search criteria set with a first set of data entry fields corresponding to a single category, denoted by the category parameter field 782. In some embodiments, the set of data entry fields 780 may include a plurality of search criteria sets having a plurality of data entry fields. The plurality of data entry fields can corresponding to a single category or a plurality of categories. As shown in FIG. 7, the data field addition element 770, once selected, can populate additional search criteria sets having a category parameter field, a first search criterion field, and a second search criterion field.

The category parameter field 782 may be understood as a first selector (e.g., data entry field) including category selection options. The category parameter field 782 may include a plurality of predetermined categories into which at least a portion of the data entered into the single ledger accounting system 100 may be organized. The categories may be understood as an organization of the entity transaction data divided based on one or more characteristic common to a set of the entity transactions included within the entity transaction data or one or more aspects of a transaction type of a set of entity transactions within the entity transaction data. As shown in FIG. 7, the category in the category parameter field 782 is “purchased,” indicating that the user is searching for data entered into the single ledger accounting system 100 for entity information of entities who have purchased items or services.

The first search criterion field 784 may be understood as a second selector (e.g., data entry field) including a set of first search criterion values populated based on a selection within the category parameter field 782. In some embodiments, the set of first search criterion values may initially include a set of default values. Certain of the set of default values may be removed from the first search criterion field 784 based on the selection within the category parameter field 782, while certain additional first search criterion values may be added to the first search criterion field 784 based on the selection. The set of default values and/or the set of first search criterion values included or added to the first search criterion field 784 may include a first characteristic associated with one or more of the entity contact information and the entity transaction data, such as one or more entity transactions of the set of entity transaction data.

The first search criterion field 784 may include a first predetermined search criterion related to the category selected from the category parameter field 782. For example, the first search criterion field 784 indicates a search for a specific item within the single ledger accounting system 100 or another linked system having listings for one or more items associated with a business or organization of the user. In some embodiments, the first search criterion field 784 may enable the user to select between searching for a specific item or any item. In some embodiments, the first search criterion field 784 may indicate a search for a specific service. Further, in some embodiments, the first search criterion field 784 may enable the user to choose between services and items before selecting a specific service or item, where the user is engaged in a business or organization which offers both services and items in conjunction with the single ledger accounting system 100. In these embodiments, the first search criterion field 784 may include selection options for a specific item, any item, a specific service, any service, or a combination of any item or service. Although presented and discussed as including a selection of an item or a service, it will be understood by one skilled in the art that the first search criterion field 784 may include any first predetermined search criterion relating to the category parameter field 782.

The first characteristic may be a characteristic chosen from a set of first characteristics describing or otherwise relating to one or more of the entity contact information and the set of entity transaction data stored in the single ledger accounting system 100. In at least some embodiments, the set of first characteristics can be understood as a set of aspects of one or more of the entity transactions included within the set of entity transaction information. For example, the set of first characteristics can include categories of purchasable items or services offered by a vendor using the single ledger accounting system 100, a designation of a subset of entity transactions indicating a purchase (e.g., whether a specific item was purchased or whether any item was purchased), timing of payment of transactions, billing aspects of payment of transactions (e.g., invoice timing, whether an invoice has been paid or is outstanding, etc.), and the like.

The second search criterion field 786 may be understood as a second selector (e.g., data entry field) including a set of second search criterion values populated based on the first search criterion selected from the first search criterion field 784 and the category parameter field 782. Similar to the first search criterion field 784, described above, the second search criterion field 786 may initially include a set of default values, where certain of the set of default values may be removed from the second search criterion field 786 or new search criterion values added to the second search criterion field 786 based on selections within the first search criterion field 784 and the category parameter field 782. The set of second search criterion values may include a second characteristic associated with one or more of the entity contact information, the entity transaction data, and the first search criterion value selected within the first search criterion field 784.

As explained above, the second search criterion field 786 may include a second predetermined search criterion related to the first search criterion in the first search criterion field 784. For example, where the first search criterion field 784 enables the user to select a specific item, the second search criterion field 786 may enable the user to choose from a set of predetermined items included in the data associated with the single ledger accounting system 100. By way of further example, where the first search criterion field 784 enables the user to select a specific service, the second search criterion field 786 may enable the user to choose from a set of predetermined specific services.

In some instances, the set of second search criterion values may be related to the set of first search criterion values in a cascade relationship. For example, the second characteristic included within the set of second search criterion values may be from a set of second characteristics understood as a set of aspects describing the set of first characteristics. In at least some embodiments, the set of second characteristics can include titles of specific purchasable items or services, amounts of transactions, time of transactions, monetary amounts for transactions (e.g., total amount of purchase, total amount paid, etc.), comparative time or amount values (e.g., more than, less than, exactly, etc.), and other characteristics describing or further narrowing the set of first characteristics.

The third search criterion field 788 may be understood as a third selector (e.g., data entry field) including a set of third search criterion values populated based on the first search criterion selected from the first search criterion field 784, the second search criterion selected from the second search criterion field 784, and the category parameter field 782. The third search criterion field 788 may include a third predetermined search criterion from the set of third search criterion values relating to any or all of group of search criteria including the category, the first search criterion, and the second search criterion. The third search criterion can include a third characteristic associated with one or more of the entity contact information, the one or more entity transaction, the category, the first characteristic, and the second characteristic. For example, as shown in FIG. 7, the third predetermined search criterion may include a set of options delineating time with respect to the category. As shown, the third predetermined search criterion field 788 enables the user to select a time period for the purchase of the item or items. Here, the time periods for selection determine whether the item or service was purchased ever or within the last two years, the last year, the last six months, the last four weeks, or the last seven days. In some embodiments, where the third predetermined search criterion relates to time, the third predetermined search criterion may be divided into increasingly larger or smaller time periods. In some embodiments, the third characteristic can be selected from a set of third characteristics included within the set of second characteristics or describing one or more of the set of first characteristics, the set of second characteristics, the category, the entity contact information, or the one or more entity transaction.

As shown in FIG. 7, the example user interface may include the set of saved searches 750a-750d. The set of saved searches 750a-750d may include a “have purchased an item” search 750a which, upon selection, configures the category parameter field 782 to “purchased,” the first search criterion field 784 to “Any Item,” the second search criterion 786 to “More than,” and the third search criterion 788 may be configured to receive data indicative of an amount or a time. In some embodiments, the “have purchased an item” search 750a may include an additional search criterion differentiating time or amount ranges.

The “Outstanding >30 days” search 750b may upon selection, configures the category parameter field 782 to “Invoice,” the first search criterion field 784 to “Outstanding,” the second search criterion 786 to “More than,” and the third search criterion 788 may be configured to receive data indicative of an amount or a time. In some embodiments, the “Outstanding >30 days” search 750b may include an additional data entry field or additional search criterion differentiating time or amount ranges.

The “Overdue >7 days” search 750c may upon selection, configures the category parameter field 782 to “Invoice,” the first search criterion field 784 to “Overdue,” the second search criterion 786 to “More than,” and the third search criterion 788 may be configured to receive data indicative of an amount or a time. In some embodiments, the “Overdue >7 days” search 750c may include an additional data entry field or additional search criterion differentiating time or amount ranges. For example, the additional data entry field may be configured to select items that are overdue “More than 7 days.”

The “Paid us” search 750d may upon selection, configures the category parameter field 782 to “Payments,” the first search criterion field 784 to “More than,” the second search criterion 786 to receive data indicative of an amount, and the third search criterion 788 may be configured to receive data indicative of a time in which the payment was made. Although the default set of searches have been described in reference to specific amounts of search criteria and data entry fields, and specific configurations of the search criteria and data entry fields, it will be understood by one skilled in the art that the specific configurations do not represent all of the possible default set of saved searches possible using the smart list module 144.

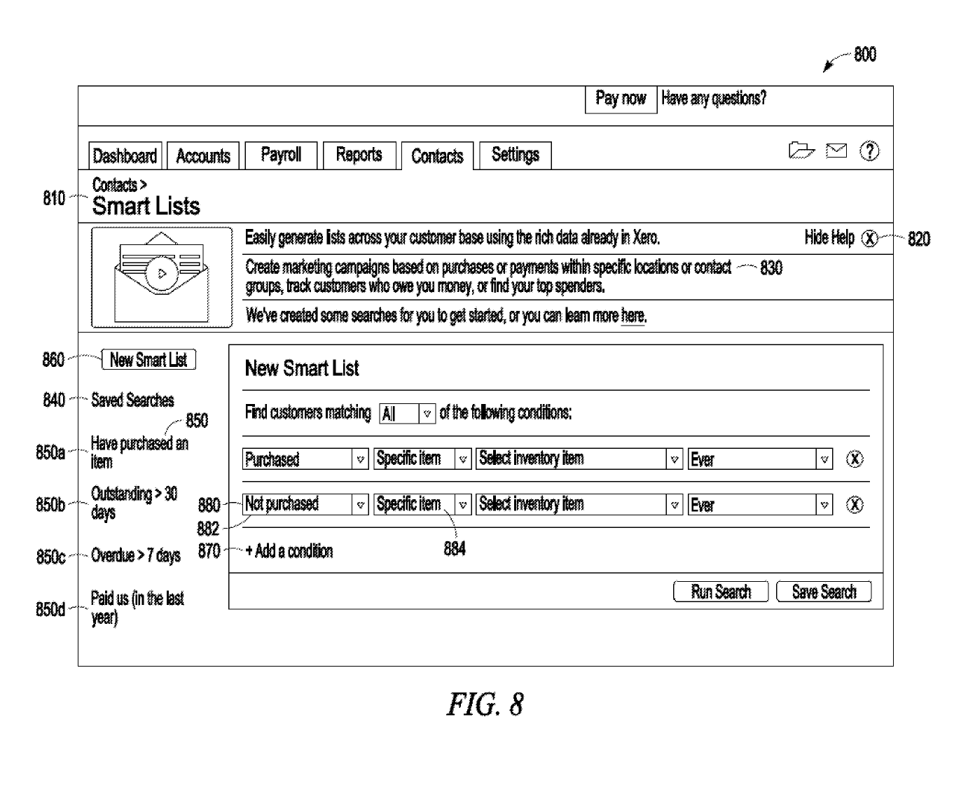

FIG. 8 shows an interface diagram depicting an example embodiment of an entity search tool 800 displaying features of the smart list generation application, according to some embodiments. The entity search tool 800 includes a title 810, a help element 820, a help tip 830, a saved search list 840, a set of saved searches 850, a new list element 860, a the data field addition element 870, and a set of data entry fields 880. The title 810, the help element 820, the help tip 830, the saved search list 840, the set of saved searches 850, the new list element 860, and the data field addition element 870 are similar to the title 710, the help element 720, the help tip 730, the saved search list 740, the set of saved searches 750, the new list element 760, and the data field addition element 770, respectively, as described above with respect to FIG. 7.

As shown, the set of data entry field 880 includes a category parameter field 882, similar to the category parameter field 782 described above. The category parameter field 882 illustrates another category included in some embodiments of the smart list generation application. The category parameter field 882 shows the category as “not purchased,” enabling the user to search for entities that have not purchased a specific item or service from the user.

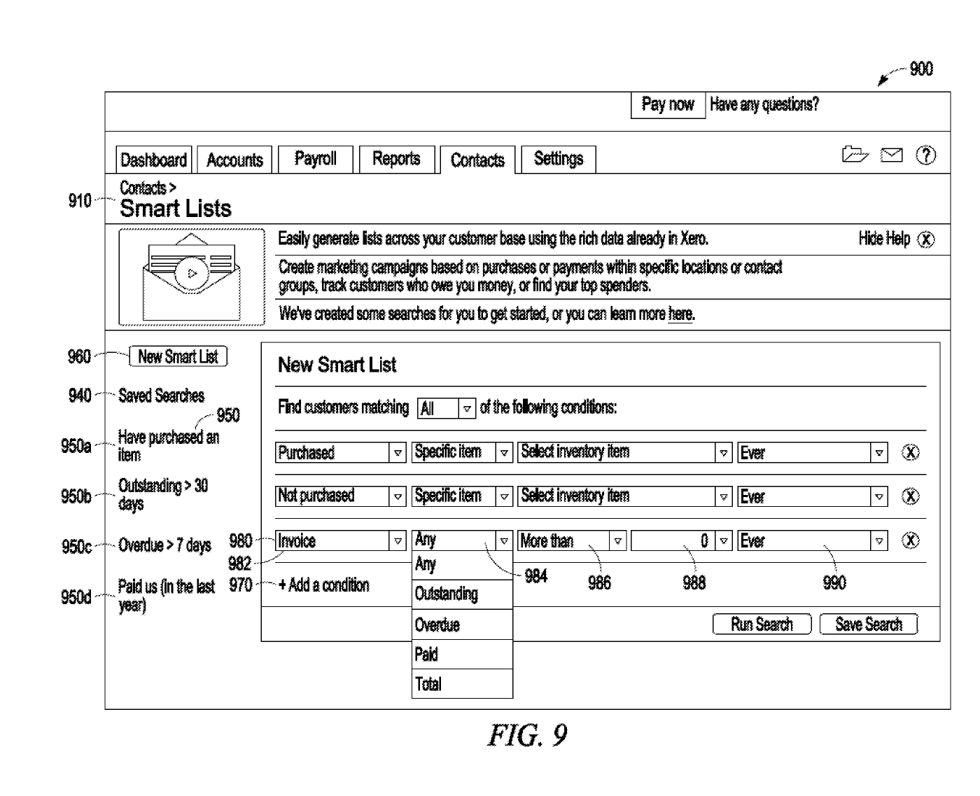

FIG. 9 shows an interface diagram depicting an example embodiment of an entity search tool 900 displaying features of the smart list generation application, according to some embodiments. The entity search tool 900 includes a title 910, a help element 920, a help tip 930, a saved search list 940, a set of saved searches 950, a new list element 960, a the data field addition element 970, and a set of data entry fields 980. The set of data entry fields 980 includes a category parameter field 982, a first search criterion field 984, a second search criterion field, 986, a third search criterion field 988, and a fourth search criterion field 990. The title 910, the help element 920, the help tip 930, the saved search list 940, the set of saved searches 950, the new list element 960, and the data field addition element 970 are similar to the title 710, the help element 720, the help tip 730, the saved search list 740, the set of saved searches 750, the new list element 760, and the data field addition element 770, respectively, as described above with respect to FIG. 7.

The category parameter field 982 may include a plurality of predetermined categories, similar to the category parameter field 782. As shown in FIG. 9, the category in the category parameter field 782 is “invoice,” indicating that the user is searching for data entered into the single ledger accounting system 100 for entity information of entities that have purchased items and have one or more invoicing activities associated with the entity. For example, selection of the invoice category may identify entities that have been sent an invoice, that have an outstanding balance on an invoice, that have paid an invoice, that are currently awaiting an invoice, or the like.

The first search criterion field 984 may include a first predetermined search criterion related to the category selected from the category parameter field 982. For example, as shown, the first search criterion field 984 enables the user to select between invoices which are outstanding, overdue, paid, or for invoices with a total having later-selected values. Although the first search criterion field 984 is shown as presenting elements of an invoice relating to amounts and timeliness, it will be understood that the first search criterion field 984 may be populated with any first predetermined first search criterion relating to the category selected in the category parameter field 982. In some embodiments, the first search criterion field 984 may be implemented similarly to the first search criterion field 784, described above, although including differing search criterion values.

The second search criterion field 986 may include a second predetermined search criterion related to the first search criterion field 984. For example, as shown, the second search criterion field 986 enables the user to select a relative value relating to the first search criterion field 984. As shown, the user may select the relative value “more than.” In some embodiments, the user may additionally select relative values such as less than, equal to, more than or equal to, less than or equal to, and the like. In some embodiments, the second search criterion field 986 may be implemented similarly to the second search criterion field 786, described above, although including differing search criterion values.

The third search criterion field 988 may include third search criterion related to the second search criterion field 986. In some embodiments, the third search criterion may be user determined and entered into a data entry field which allows free form entry of data, such as a dollar amount or a length of time. In some embodiments, the third search criterion may be a third predetermined search criterion enabling the user to choose from a set of listed amounts relating to the second search criterion field 986. For example, as shown the third search criterion field may enable the user to enter a numerical entry specifying an amount of time or money relating to the nature of the invoice as outstanding, overdue, paid, or relating to the total of the invoice. In some embodiments, the third search criterion field 988 may be implemented similarly to the third search criterion field 788, as described above, although including differing search criterion values.

The fourth search criterion field 990 may include a fourth predetermined search criterion relating to any or all of group of search criteria including the category, the first search criterion, and the second search criterion. For example, as shown in FIG. 9, the fourth predetermined search criterion may include a set of options enabling selection of a time with respect to the category. As shown, the fourth predetermined search criterion field 990 enables the user to select a time period for the invoice. Here, the time periods for selection determine whether the invoice was generated, transmitted, received, paid, or the like in a time period of ever, within the last two years, within the last year, within the last six months, within the last four weeks, or within the last seven days. In some embodiments, where the fourth predetermined search criterion relates to time, the fourth predetermined search criterion may be divided into increasingly larger or smaller time periods. In some embodiments, the fourth search criterion field 990 may be implemented similarly to the third search criterion field 988 or the third search criterion field 788, as described above, although having differing search criterion values. For example, a set of fourth search criterion values, from which a fourth search criterion within the fourth search criterion field 990 may be selected, can include a set of fourth characteristics. The set of fourth characteristics can be included within the set of third characteristics, the set of second characteristics, or describing or further narrowing one or more of the set of third characteristics and the set of second characteristics.

Although shown in FIGS. 7-9 as including categories of purchased, not purchased and invoice, the categories associated with the category parameter field 782, 882, or 982 may include any suitable categories, such as payments, location, contact group, or the like related to an entity associated with a business or organization. For example, the entity may be a customer of the business or organization. Similarly, search criterion fields, such as the first search criterion fields 874, 884, or 984 may include varying first predetermined search criteria relating to the varying categories of the category parameter field.

As stated above, with respect to the first search criterion field 784 and the second search criterion field 786, in some embodiments, the entity search tool (e.g., the entity search tool 600, 700, 800, or 900) can add or remove search criterion values from the search criterion fields based on selections of one or more of the first selector, the second selector, and the third selector. Similarly, the entity search tool, according to some embodiments, can automatically provide one or more additional selectors (e.g., in addition to the first selector, the second selector, and the third selector) or one or more search criteria set based on selections of the first selector, the second selector, and the third selector.

As mentioned above, each of the first selector, the second selector, and the third selector may be provided with a set of default categories or values representative of search options within one or more data entry fields, such as the first search criterion field 784, the second search criterion field 786, and the third search criterion field 786. In some embodiments, a subset of the selectors may be implemented as free form data entry fields capable of receiving input from a user in a form other than a set of preselected options, such as a text string, a number string, or other suitable input.

Where the selectors contain default selectable categories or values, the entity search tool may determine selections made in one or more of the selectors (e.g., a selection in the first selector and a selection in the second selector) and provide a suggested value for a subsequent selector (e.g., a suggested value of the set of third search criterion values). The suggested value may be presented to the user in a manner configured to indicate a value as the suggested value. For example, the suggested value may be automatically populated into the subsequent selector. In these instances, the entity search tool may present the suggested value and enable the user to perform an affirmative action of selecting another value to override the suggested value within the subsequent selector.

By way of further example, the suggested value may be highlighted within the set of search criterion values presented within the subsequent selector. In this instance to highlight a value, the suggested value within the set of search criterion values may be highlighted (e.g., presenting the suggested value in a colored field differing from the surrounding search criterion values, presenting the font of the suggested value as differing from the remaining values of the set of search criterion values, etc.). In some embodiments, the suggested value may remain within a predetermined order for the set of search criterion values. In some instances, the suggested value may be highlighted and prominently ordered within the set of search criterion values (e.g., presented at the top of a drop down list of the set of search criterion values).

Where the selectors are free form data entry fields, the entity search tool may present a suggested value by automatically populating the suggested value into the free form data entry field. In this instance, the entity search tool may enable the user to override the suggested value by deleting, overwriting, typing a desired value into the free form data entry field. In some embodiments, where the suggested value is automatically populated into the free form data entry field, the entity search tool may present the suggested value as an overlay or background of the free form data entry field (e.g., gray text within a text entry field).

In some further embodiments, the entity search tool may present the suggested value proximate to the free form data entry field. For example, when the user selects the free form data entry field for entry of a value, the entity search tool may present the suggested value in drop down list below the free form data entry field, where the drop down list extends downwardly from the free form data entry field once the user selects the free form data entry field or begins typing into the free form data entry field.

As stated above, the entity search tool can cause presentation of one or more subsequent selectors based on selections of one or more of the first selector, the second selector, and the third selector. In some instances, a subsequent selector may be provided with a predetermined type of data entry method based on the selection causing the subsequent selector to be presented. For example, where a selection in one of the first selector, the second selector, or the third selector includes a search criterion value indicating a date selection option, the subsequent selector may contain representations of dates, date range limits, times, time range limits, or any other suitable data type relating to a date selection. The subsequent selector may be presented by the entity search tool immediately after the selector containing the selection causing the generation and display of the subsequent selector. In some instances, the subsequent selector may be displayed in a linear relationship with the first selector, the second selector, and the third selector and be positioned in the linear relationship after the third selector.

In some embodiments, as stated above, the entity search tool may cause presentation of a search criteria set based on one or more selections of the first selector, the second selector, and the third selector. In these embodiments, the entity search tool may determine that the one or more selections are associated with one or more other selections indicating a subsequent query. The entity search tool may generate one or more selectors and automatically populate the one or more selectors with category parameters and search criterion values associated with the subsequent query determined to be associated with the one or more selections. The entity search tool may also cause presentation of one or more user interface elements enabling the user to accept or cancel the suggested search criteria set. Further, the entity search tool may enable the user to modify the automatically populated one or more selectors to modify the suggested search criteria set to tailor the subsequent query suitable to the purposes of the user.

The entity search tool may determine the associated subsequent query based on searches, queries, pre-set searches, saved searches, or other access of the entity search tool by other users within the system or external data (e.g., economic data). For example, the entity search tool can receive searches input by the user into the input module 530 and store the searches in a set of searches for further query. The entity search tool may retrieve and re-run stored searches or retrieve stored results of stored searches to send suggested searches or pre-run search results to the user. In some embodiments, the entity search tool uses one or more selections of the stored searches to perform a search on data external to the smart list module 144 or the single ledger accounting system 100. In some instances, the entity search tool may apply one or more algorithm to the one or more stored search to generate suggested searches to provide suggested searched results to the user.

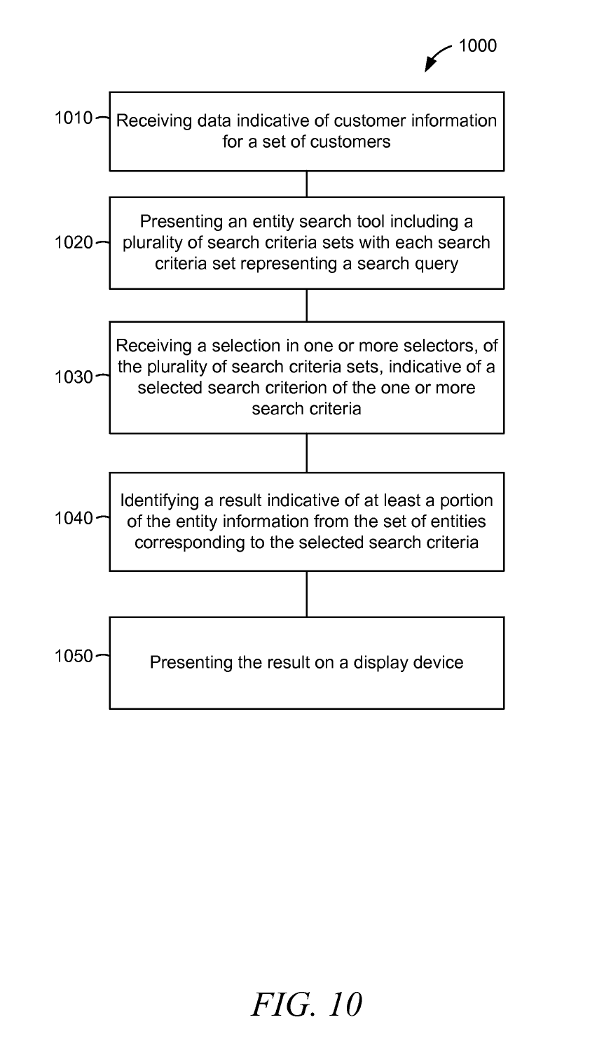

Referring now to FIG. 10, therein shown is a flow chart of a method 1000 for generating sets of entity transaction information (e.g., lists of entity transactions or lists of entity contact information based on entity transaction commonalities) by using the entity search tool employing the smart list generation application, according to some embodiments. The method 1000 includes operation 1010-1050, which generate sets of entity transaction information and enable transformation of that entity transaction information. The operations of the method 1000 may be performed by a mobile device, a desktop device, or other user device using modules such as those shown in FIG. 5.

In operation 1010, data is received by the input module 530. The data is indicative of entity information for a set of entities. In some embodiments, the entity information comprises, for each entity of the set of entities, entity contact information and a set of entity transactional information.

The entity contact information may include data indicative of information such as a name, an address, a location, a telephone number, an email address, and other information which may be used to contact the entity. In some embodiments, the entity contact information includes data indicative of a contact group. In some embodiments, the contact group is a grouping of entity contact information indicative of a relationship between the entities. For example, the contact group may indicate a familial relationship or a cohabitation relationship between entities. By way of additional example, the contact group may indicate a group of entities to whom a common promotion or advertisement has been sent.

The set of entity transactional information may include, purchase information, a product purchased, a time of last purchase, an invoice date, a last invoice date, a purchase value, a total purchase value, an historical purchase value for the duration of the entity's patronage of an organization, a historical invoice statement indicative of the times and timeliness of payment for purchases made from the organization by the entity, products or items not purchased by the entity from the organization. With regard to products purchased or not purchased by the entity, the purchase information may additionally include data indicative of a time element. For example, the purchase information may include the last time a purchase of a particular product was made (e.g., in the last two years, in the last year, in the last six months, in the last four weeks, in the last seven days, in the last twenty-four hours, ever, etc.). The purchase information may also include time information relating to a product not purchased by the entity. For example, the time data may be indicative of the entity not having purchased a product ever, in the last two years, in the last year, in the last six months, in the last four weeks, in the last seven days, in the last twenty-four hours, or the like.

In some embodiments, the purchase information includes an inventory item, a location of a purchase, a time of purchase indicating the recency of the purchase (e.g., in the last 2 years, in the last year, in the last 6 months, in the last 4 weeks, in the last 7 days, in the last 24 hours, etc.), an entity invoice, a current invoice amount indicative amounts of money owed or paid to the organization by the entity. For example, the current invoice amount may be indicative of money owed, indicating an account associated with an entity is outstanding or overdue, money paid, a total amount of an invoice prepared by the organization, or other information pertinent for inclusion in an invoice relating to balances or payments reflected on the invoice. In some embodiments, the purchase information includes payment information, such as payment status, payment amounts, installment agreement terms, payment of installments, and the like.

Further, in some embodiments, the input module 530 receives data indicative of a set of inventory. The set of inventory may comprise one or more items or products produced, sold, traded, or otherwise associated with the organization. The set of inventory may further comprise data comprising, for each of the items, an item identifier, a purchase price, an item description, and any other suitable data relating to the item, its manufacture, production, sale, trade, or association with the organization.

In embodiments, the input module 530 receives data indicative of a set of services. The set of services may comprise one or more services, operations, or actions offered, engaged in, consulted upon, or otherwise associated with the organization. The data may comprise a service identifier, a purchase price, a service description, or other suitable information.

In operation 1020, the display module 520 may present an entity search tool. The entity search tool may be presented on a display device, such as a screen associated with the client device 480. The entity search tool may comprise a plurality of search criteria sets, with each search criteria set representing a search query. Each search criteria set of the plurality of search criteria sets may include a set of selectors. For example the set of selectors may be a set of data entry fields, as described above with respect to FIGS. 7-9. In some embodiments, the selectors of each search criteria set include a plurality of predetermined search criteria or category parameters. For example, the selectors may be implemented as one or more drop down menu. The one or more drop down menu may each have a plurality of search criterion values selectable by a user for inclusion in a search of the entity information. The one or more search criterion value contained in the selector may include a categorization of the individual types of entity information. For example, the one or more search criterion value may include a category of contact information, which includes all of the types of contact information associated with entities of the organization (e.g., names, telephone numbers, email addresses, etc.).

As shown in FIGS. 7-9, when the display module 520 presents the entity search tool and the plurality of search criteria sets, each search criteria set may form a search query and include a first selector (e.g., the category parameter field 782), a second selector (e.g., the first search criterion field 784), and a third selector (e.g., the second search criterion field 786). The first selector, as discussed above, may be operable to select a category parameter. The category parameter may be indicative of a correlation of entity contact information and one or more entity transaction of a set of entity transaction information. The second selector, as described above, may be operable to select a first search criterion from a set of first search criterion values. The set of first search criterion values are based on the category parameter, presented for selection in the first selector. The set of first search criterion values include a first characteristic associated with one or more of the entity contact information and the one or more entity transaction. The third selection, as described above, may be operable to select a second search criterion from a set of second search criterion values. The set of second search criterion values may be based on the first search criterion, presented for selection in the second selector and the category parameter presented for selection in the first selector. The second search criterion may include a second characteristic associated with one or more of the entity contact information, the one or more entity transaction, and the first characteristic.

In some embodiments, the plurality of search criteria sets include a plurality of predetermined searches. Each of the plurality of predetermined searches may comprise a combination of selections of the one or more search criterion values associated with the selectors. The plurality of predetermined searches may be displayed by the display module 520 as a configuration of the selectors which are automatically configured upon selection of one of the plurality of predetermined searches. In some embodiments, a processor of a machine automatically configures the selectors to correspond to the selected one of the plurality of predetermined searches, without user interaction or input beyond selecting the one of the plurality of predetermined searches. For example, a predetermined search used to determine whether an entity has purchased a widget within the last six months may correspond to a predetermined search entitled “widget.” The predetermined search may be stored as a selectable option in one of the set of data entry fields designated for predetermined searches, such as the saved search list 640. The user, desiring to determine which entities have purchased a widget in the last six months may select the saved search list 640 and then select the “widget” search in a data entry field designated for predetermined searches and displayed upon selection of the save search list 640. Once the “widget” search is selected by the user, the processor of the machine may configure appropriate ones of the set of data entry fields to select search criteria including a widget and a time limitation of a purchase within the last six months.

In some embodiments, a user creates a saved search from selections of search criterion values within the selectors. In these embodiments, the user may make selections of one or more search criterion values. The input module 530 may store the selected search criterion values in a non-transitory machine-readable medium. The input module 530 may also store a configuration of the selectors corresponding to the selection in one or more of the selectors indicative of the selected search criterion values.

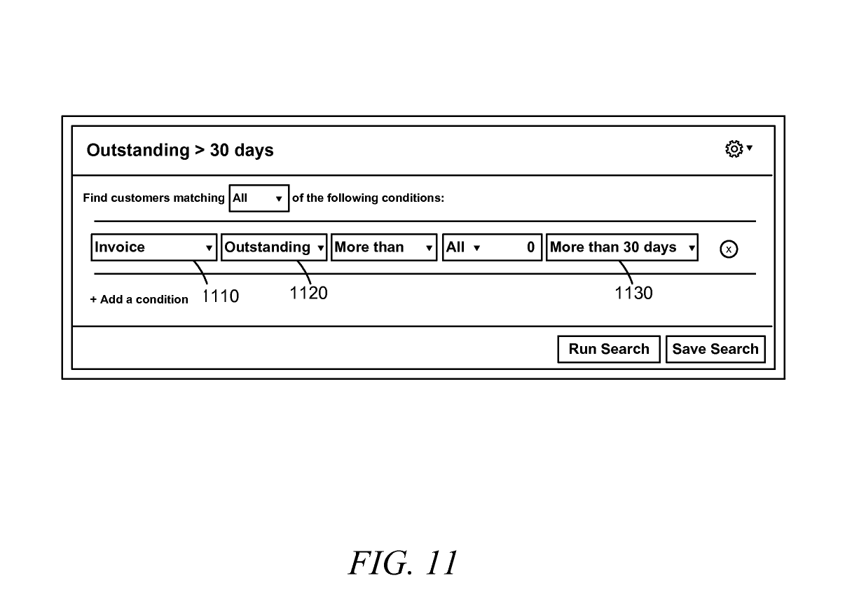

In operation 1030 the input module 530 receives a set of selections in one or more of the selectors of the plurality of search criteria sets. The set of selections is indicative of a selected search criterion value from a set of category parameters, the set of first search criterion values, and the set of second search criterion values. For example, as shown in FIG. 11, a user may desire to search for entities having an invoice outstanding for more than thirty days. The user may select a first selector 1110 from a set of selectors to indicate a search among invoices from a list of available search categories including invoices, products, purchased products, not purchased products, and other suitable categories represented within the first selector 1110. The user may then select a second selector 1120 from the set of selectors for a first search criterion within the selected category. In some instances, the first search criterion may be a sub-category associated with the first category. As shown in FIG. 11, the user may select the second selector 1120 to indicate a search for outstanding invoices. The user may additionally select a third selector 1130 from the set of selectors for a time limitation and select a limitation of invoices outstanding for more than thirty days. The user may then execute the search such that the input module 530 receives the selections in the first selector 1110, the second selector 1120, and the third selector 1130.

In some embodiments, when the user executes the search, the input module 530 transmits one or more data packets indicative of the selections made by the user. For example, the input module 530 may transmit a JavaScript Object Notation (JSON) packet to the data processing module 540. The JSON packet may be processed by the data processing module 540 through one or more algorithms to build a query (e.g., a dynamic SQL query) that is run against the entity information data.

Example, code for the JSON packet may include:

```
{
    “LeadSearchId”:“”,
    “Name”:“”,
    “MatchingType”:“MATCHINGTYPE/ALL”,
    “Conditions”:[{
        “ConditionType”:“CONDITION/INVOICES”,
        “InvoiceStatus”:“INVOICESTATUS/OUTSTANDING”,
        “CompareType”:“COMPARETYPE/ISMORETHAN”,
        “Amount”:0,
        “Currency”:“CURR/ALL”,
        “DateRange”:“DATERANGE/MORETHAN30DAYS”
    }]
}
```

Referring again to FIG. 10, in operation 1040, the data processing module 540 may identify a result indicative of at least a portion of the entity information from the set of entities. The result may correspond to the selected search criteria of the plurality of criteria sets. In some embodiments, to identify the result, the data processing module 540 determines entity information which matches or corresponds to the search criterion selected in the selectors. The data processing module 540 may include in the result entities having data included in their entity information which is thus matched with the one or more selected search criterion.

In operation 1050, the display module 520 may present the result on a display device. In some embodiments, the display module 520 presents the result in an interactive manner such that the user may add or remove additional entities to or from the result by performing selections on entity information for the set of entities through the input module 530.

In some embodiments, the method 1000 is be performed by a single machine with one or more processors. In these embodiments all of the operations 1010-1050 are performed on or by the machine.

In some embodiments, the method 1000 is performed across multiple machines. In these embodiments, a first machine may be in communication with a second machine. In some of these embodiments, the first machine receives the data indicative of entity information, as in operation 1010. The second machine receives the selection in one or more of the set of selectors, as in operation 1030. In some embodiments, the second machine further transmits data indicative of the selection of the selected search criteria to the first machine, in conjunction with operation 1030. The first machine or the second machine may identify the result, as in operation 1040. In some embodiments where the second machine has transmitted data indicative of the selection of the selected search criteria to the first machine, the first machine identifies the result and transmits data indicative of the result to the second machine.

Similarly, in some embodiments, the method 1000 is performed across multiple processors in a single machine (e.g., on a machine with a multi-core processor). Where performed on a machine with multiple processors, a first processor may perform some of the operations 1010-1050, while a second processor in the same machine may perform other of the operations 1010-1050.

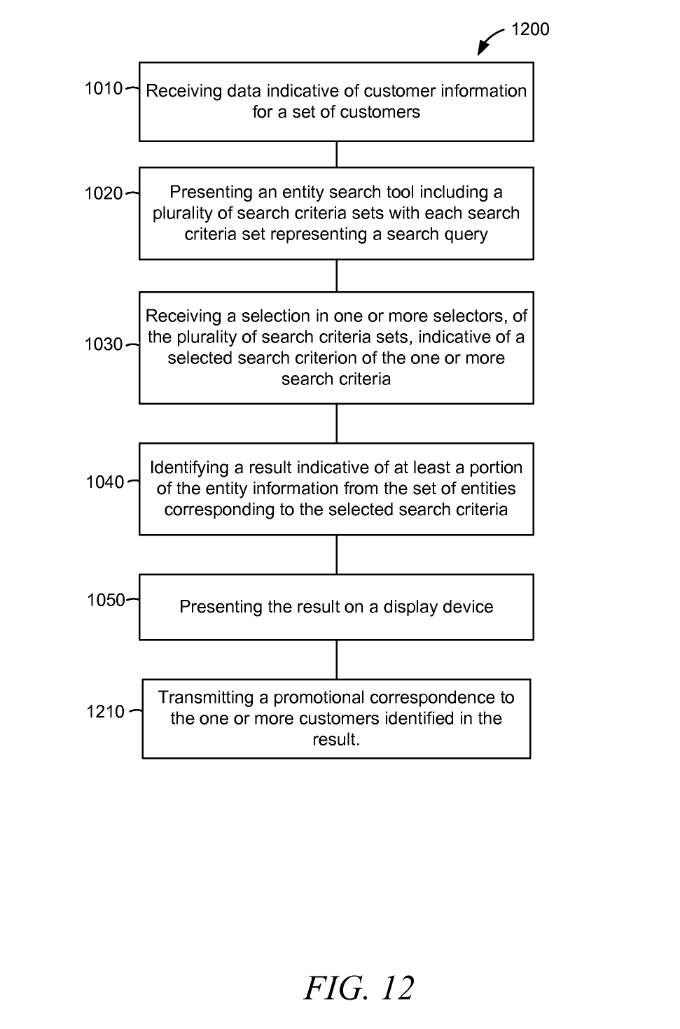

FIG. 12 is a flow chart of an example method 1200 for engaging in promotional correspondence in conjunction with the generation and transformation of entity information, such as by using smart list generation application, according to some embodiments. Promotional correspondence may be understood to be correspondence (e.g., messages, email, mail, etc.) transmitted between a vendor using the entity search tool and smart list application and an entity (e.g., a customer or potential customer) of the vendor. Promotional correspondence may include promotional materials such as advertisements, solicitations, product purchase reminders, subscription renewal notices, update notices, and other suitable correspondence. Promotional correspondence may include some information about the entity to which the promotional correspondence is addressed. The information may include contact information, prior transaction information, future transaction information (e.g., scheduled purchases or payments), current invoicing (e.g., current amounts owed for products or services purchased from the vendor), past invoicing, future invoicing, and other information which may be contained within or accessed by the entity search tool and the single ledger accounting system 100. In some embodiments, once an entity has been identified for promotional correspondence (e.g., identified in a result of the search entity tool) the search entity tool may automatically insert the information for the entity into promotional correspondence corresponding to the search query producing a result set including the entity.

In some embodiments, the method 1200 is performed in part by performing the operations 1010-1050 of method 1000. The method 1200 may further include operation 1210. In operation 1210, the communication module 510 in conjunction with the data processing module 540 may transmit a promotional correspondence to the one or more entities identified in the result. The promotional correspondence may be indicative of one or more items from a set of inventory or services corresponding to the one or more search criteria.

In some embodiments, the method 1200 is performed by multiple machines. For example, as continued from the multiple machine embodiment discussed above, the second machine may transmit the result indicative of at least the portion of the entity information corresponding to the one or more search criteria to a third machine. In these embodiments, the data indicative of the one or more items or services may be transmitted to the third machine. The third machine may then transmit the promotional correspondence.

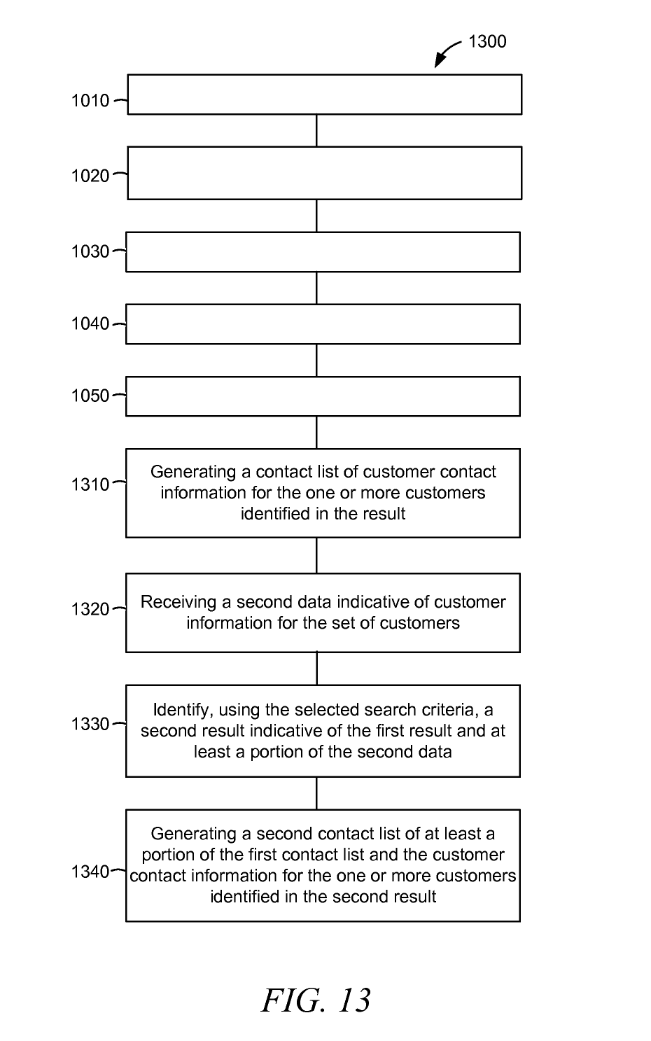

Referring now to FIG. 13, therein shown is a flow chart of an example method 1300 for generating contact lists, according to some embodiments. In some example embodiments, the method 1300 is initially performed by performing operations 1010-1050. Further, the method 1300 may be performed by generating a contact list comprising entity contact information for the one or more entities identified in the result, as in operation 1310.

In some embodiments, the data indicative of the entity information may be a first data indicative of entity information, the result may be a first result, and the contact list may be a first contact list. In operation 1320 a second data may be received. The second data may be indicative of second entity information for the set of entities.

In operation 1330, the selected search criteria stored in the non-transitory machine-readable medium may be used, without interaction from a user, to identify a second result indicative of the first result and at least a portion of the second entity information from the one or more entities corresponding to the selected search criteria.

In operation 1340, a second contact list is generated. The second contact list may comprise at least a portion of the first contact list and the entity contact information for the one or more entities identified in the second result.

Certain embodiments are described herein as including logic or a number of components, modules, or mechanisms. Modules may constitute hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

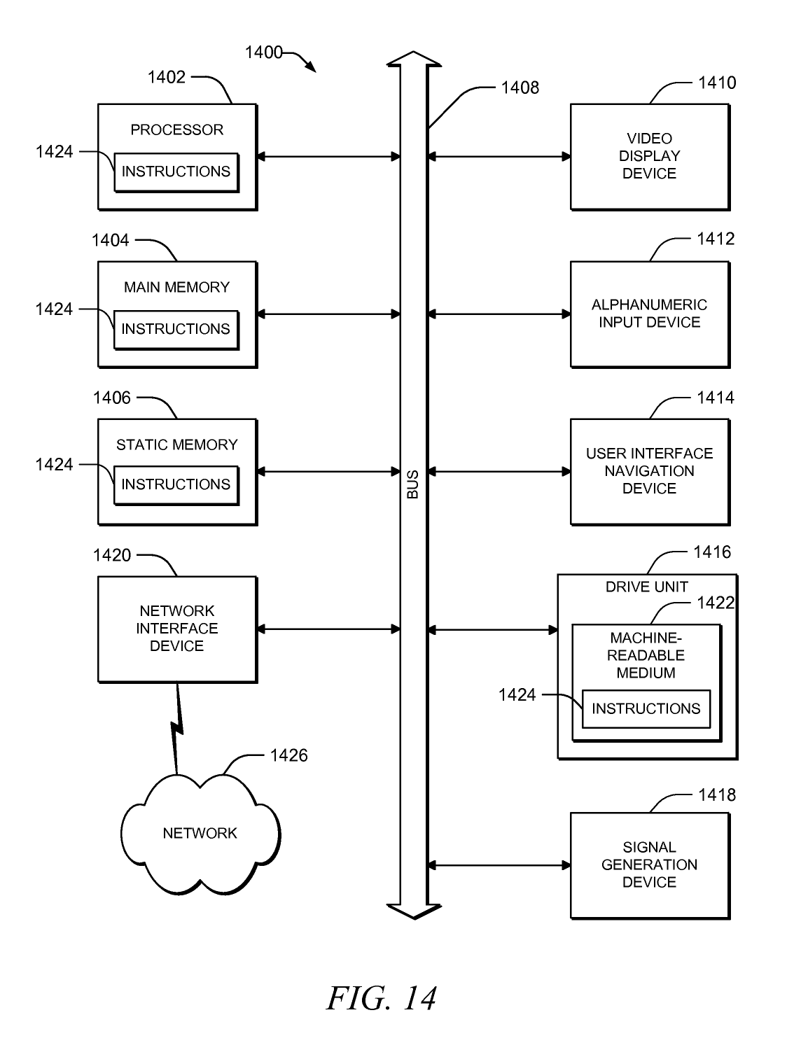

FIG. 14 is a block diagram of a machine in the example form of a computer system 1400 within which instructions, for causing the machine to perform any one or more of the methodologies discussed herein, may be executed, according to some embodiments. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 1400 includes a processor 1402 (e.g., a central processing unit (CPU), a graphics processing unit (GPU), or both), a main memory 1404, and a static memory 1406, which communicate with each other via a bus 1408. Computer system 1400 may further include a video display device 1410 (e.g., a liquid crystal display (LCD) or a cathode ray tube (CRT)). Computer system 1400 also includes an alphanumeric input device 1412 (e.g., a discrete keyboard or keyboard implemented using a touch screen of the video display device 1410), a user interface navigation device 1414 (e.g., a mouse or touch sensitive display), a disk drive unit 1416, a signal generation device 1418 (e.g., a speaker), and a network interface device 1420.

Disk drive unit 1416 includes a machine-readable medium 1422 on which is stored one or more sets of instructions and data structures (e.g., software) 1424 embodying or utilized by any one or more of the methodologies or functions described herein. Instructions 1424 may also reside, completely or at least partially, within main memory 1404, within static memory 1406, and/or within processor 1402 during execution thereof by computer system 1400, main memory 1404 and processor 1402 also constituting machine-readable media.

While machine-readable medium 1422 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 1424 may further be transmitted or received over a communications network 1426 using a transmission medium. Instructions 1424 may be transmitted using network interface device 1420 and any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method comprising:
receiving, by a processor of a first machine, data indicative of entity information for a set of entities, the entity information comprising, for each entity of the set of entities, entity contact information and a set of entity transactional information, the entities being customers of an organization;
presenting, on a display device of a second machine associated with the organization, an entity search tool comprising:
a plurality of search criteria sets, each search criteria set of the plurality of search criteria sets forming a search query and comprising:
a first selector operable to select a category parameter, the category parameter indicative of a correlation of the entity contact information and one or more entity transaction of the set of entity transaction information;
a second selector operable to select a first search criterion from a set of first search criterion values, the set of first search criterion values being based on the category parameter and including a first characteristic associated with one or more of the entity contact information and the one or more entity transaction; and
a third selector operable to select a second search criterion from a set of second search criterion values, the set of second search criterion values being based on the first search criterion and the category parameter, the second search criterion including a second characteristic associated with one or more of the entity contact information, the one or more entity transaction, and the first characteristic;
receiving, at the machine associated with the organization, a selection in the plurality of search criteria sets based on user interaction with the first selector, the second selector, and the third selector, the user being associated with the organization, the set of selections including a first selection of the first selector causing population of the second selector, a second selection of the second selector causing population of the third selector, and a third selection of the third selection, and one or more of the set of selections including a timing of payment of the one or more entity transaction;
building a query based on the first selection, the second selection, and the third selection;
identifying, responsive to the query, a result indicative of at least a portion of the entity information from the set of entities corresponding to the selected search criteria of the plurality of search criteria received by the machine associated with the organization, the result indicating one or more of the set of entities as having a transaction outstanding with the organization; and
presenting the result on the display device of the second machine associated with the organization.

2. The method of claim 1 further comprising:
receiving, by the processor of the first machine, data indicative of a set of inventory, the set of inventory comprising one or more items, the data comprising, for each of the items, an item identifier and a purchase price.

3. The method of claim 1 further comprising:
receiving, by the processor of the first machine, data indicative of a set of services, the data comprising a service identifier and a purchase price.

4. The method of claim 1 further comprising:
receiving data indicative of an entity invoice, the data identifying a payment status.

5. The method of claim 1, wherein the first machine is the second machine.

6. The method of claim 1, wherein identifying the result is performed by the first machine.

7. The method of claim 1, wherein identifying the result is performed by the second machine.

8. The method of claim 1 further comprising:
transmitting, by the processor of the second machine, data indicative of the selection of the selected search criterion to the first machine; and
transmitting, by the first machine, data indicative of the result to the second machine.

9. The method of claim 1 further comprising:
transmitting a promotional correspondence to the one or more entities identified in the result, the promotional correspondence being indicative of one or more items from a set of inventory corresponding to the selected search criteria.

10. The method of claim 9, wherein the promotional correspondence is transmitted by a processor of a third machine and further comprising:
transmitting, by the processor of the second machine, the result indicative of at least the portion of the entity information corresponding to the selected search criteria; and
transmitting data indicative of one or more items, from the set of inventory, corresponding to the selected search criteria.

11. The method of claim 1, wherein the plurality of search criteria sets include a plurality of predetermined searches, each of the plurality of predetermined searches comprising a combination of the first set of search criterion values and the second set of search criterion values.

12. The method of claim 1, further comprising:
storing the selected search criteria in a non-transitory machine-readable medium; and
storing a configuration of the plurality of search criteria sets corresponding to the selection in the one or more of the first selector, the second selector, and the third selector indicative of the selected search criteria.

13. The method of claim 12 further comprising:
generating a contact list comprising entity contact information for the one or more entities identified in the result.

14. The method of claim 13, wherein the data indicative of entity information is a first data indicative of entity information, the result is a first result, and the contact list is a first contact list, and further comprising:
receiving a second data indicative of second entity information for the set of entities;
identifying, using the selected search criteria stored in the non-transitory machine-readable medium and without interaction from a user, a second result indicative of the first result and at least a portion of the second entity information from the one or more entities corresponding to the selected search criteria; and
generating a second contact list comprising at least a portion of the first contact list and the entity contact information for the one or more entities identified in the second result.

15. A system associated with an organization as a first machine, comprising:
one or more processors; and
a non-transitory machine readable medium coupled to the processors, the non-transitory machine readable medium storing instructions which, when executed by the one or more processors, cause the one or more processors to:
receive data indicative of entity information for a set of entities, the data comprising entity contact information and entity transactional information for each entity of the set of entities, the entities being customers of the organization;
present an entity search tool at a display device of a second machine associated with the organization, the entity search tool comprising:
a plurality of search criteria sets, each search criteria set of the plurality of search criteria sets forming a search query and comprising:
a first selector operable to select a category parameter, the category parameter indicative of a correlation of the entity contact information and one or more entity transaction of the set of entity transaction information;
a second selector operable to select a first search criterion from a set of first search criterion values, the set of first search criterion values being based on the category parameter and including a first characteristic associated with one or more of the entity contact information and the one or more entity transaction; and
a third selector operable to select a second search criterion from a set of second search criterion values, the set of second search criterion values being based on the first search criterion and the category parameter, the second search criterion including a second characteristic associated with one or more of the entity contact information, the one or more entity transaction, and the first characteristic;
receive, from the second machine, at the machine associated with the organization, a selection in the plurality of search criteria sets based on user interaction with the first selector, the second selector, and the third selector, the user being associated with the organization, the set of selections including a first selection of the first selector causing population of the second selector, a second selection of the second selector causing population of the third selector, and a third selection of the third selection, and one or more of the set of selections including a timing of payment of the one or more entity transaction;
build a query based on the first selection, the second selection, and the third selection;
identify, responsive to the query, a result indicative of at least a portion of the entity information from the set of entities corresponding to the selected search criteria of the plurality of search criteria sets received from the second machine associated with the organization, the result indicating one or more of the set of entities as having a transaction outstanding with the organization; and
present the result on the display device of the second machine associated with the organization.

16. The system of claim 15, wherein the instructions further cause the one or more processors to:
receive data indicative of a set of inventory, the set of inventory comprising one or more items, the data comprising, for each of the items, an item identifier and a purchase price.

17. The system of claim 16, wherein the instructions further cause the one or more processor to:
transmit a promotional correspondence to the one or more entities identified in the result, the promotional correspondence being indicative of one or more items from the set of inventory corresponding to the selected search criteria.

18. The system of claim 15, wherein the instructions further cause the one or more processors to:
receive data indicative of a set of services, the data comprising a service identifier and a purchase price.

19. The system of claim 15, wherein the instructions further cause the one or more processors to:
receive data indicative of an entity invoice, the data identifying a payment status.

20. A non-transitory machine-readable medium storing instructions which, when executed by one or more processors, cause the one or more processors to perform operations comprising:
receiving data indicative of entity information for a set of entities, the data comprising, for each entity of the set of entities, entity contact information and entity transactional information, the entities being customers of an organization;
presenting an entity search tool on a machine associated with the organization, the entity search tool comprising:
a plurality of search criteria sets, each search criteria set of the plurality of search criteria sets forming a search query and comprising:
a first selector operable to select a category parameter, the category parameter indicative of a correlation of the entity contact information and one or more entity transaction of the set of entity transaction information;
a second selector operable to select a first search criterion from a set of first search criterion values, the set of first search criterion values being based on the category parameter and including a first characteristic associated with one or more of the entity contact information and the one or more entity transaction; and
a third selector operable to select a set of second search criterion values, the set of second search criterion values being based on the first search criterion and the category parameter, the second search criterion including a second characteristic associated with one or more of the entity contact information, the one or more entity transaction, and the first characteristic;
receiving, at the machine associated with the organization, a selection in the plurality of search criteria sets based on user interaction with the first selector, the second selector, and the third selector, the user being associated with the organization, the set of selections including a first selection of the first selector causing population of the second selector, a second selection of the second selector causing population of the third selector, and a third selection of the third selection, and one or more of the set of selections including a timing of payment of the one or more entity transaction;
building a query based on the first selection, the second selection, and the third selection;
identifying, responsive to the query, a result indicative of at least a portion of the entity information from the set of entities corresponding to the selected search criteria of the plurality of search criteria received by the machine associated with the organization, the result indicating one or more of the set of entities as having a transaction outstanding with the organization; and
presenting the result on a display device of the machine associated with the organization.
